(19) United States
(12) Patent Application Publication
(10) Pub. No.: US 2002/0093515 A1
(43) Pub. Date: Jul. 18, 2002

(54) Method of measuring and sizing objects from an image of a human face using iris size

(76) Inventors: Pierre N. Fay, New York, NY (US); Michael P. Shanley, Rochester, NY (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/883,121

(22) Filed: Jun. 15, 2001

Related U.S. Application Data
(60) Provisional application No. 60/211,903, filed on Jun. 16, 2000.

(51) Int. Cl. G09G 5/00

(52) U.S. Cl. 345/629; 382/286

(57) ABSTRACT

A method for determining one or more dimensions of an object in a two-dimensional image, wherein the image includes the iris of a human being. A size ratio is estimated between the dimension of the object and the diameter of the visible iris, by analyzing the two-dimensional picture. Then, the dimension of the object is approximated based upon the size ratio and also based upon the invariant iris diameter. Use is made of the fact that the diameter of a human iris is substantially identical for all humans above the age of two, and thus an image which includes someone's iris furnishes a measuring device for determining other dimensions in the image. The present invention is especially suited for examining, virtually trying on, and purchasing eyewear from a remote location.

### TECHNICAL FIELD OF THE INVENTION

The present invention relates to a method for measuring and sizing objects depicted in a visual image, and more particularly for measuring and sizing a human face by visual imaging.

### BACKGROUND OF THE INVENTION

Historically, personal products such as eyewear, which must fit precisely on a user's face, and which need to have the lenses arranged at the proper interocular distance (i.e. the distance between the eyes), have had to be physically arranged on the actual user's face, in person, in order to ensure a proper fit. This requires the user to physically visit a specialist's office or physically visit a merchant, which is time-consuming, and also limits the selection of frames or other accessories to those which the specialist or the merchant can immediately obtain. These same problems apply to other personal products, such as wigs, rings, clothing items, et cetera.

### DISCLOSURE OF THE INVENTION

The present invention overcomes the disadvantages discussed above by providing a method for scaling, sizing and fitting eyeglasses or other personal products used in proximity to an image of the iris of the human eye, by first taking an image of the user's face via an imaging device which may be located remotely from the merchant in a place which is convenient for the user. Second, the image is processed and scaled to provide an accurate measurement of the dimensions of the user's face, such as the interocular measurement, by using the fact that the human iris for almost all people over the age of two is remarkably constant in diameter. Therefore, the iris acts like a built-in ruler when an image including the iris is taken. Therefore, given that the diameter of the iris is a constant, with this information, an image of a human face, for example, will contain a number of pixels within the diameter of the iris in the image. Therefore, a ratio of millimeters to pixels can be utilized to determine any distance on the image. Thus, the method of the present invention allows an accurately sized, and scaled, pair of glasses to be purchased without physically visiting a specialist or a merchant. Furthermore, the method of the present invention allows a virtual “try-on” by the consumer of personal products such as eyeglasses or cosmetics over a computer network wherein accurately scaled products can be viewed on or near the image of the user. Additionally, goods such as furniture or clothing can also be sized to the user. Further, any image or picture from any source which includes an iris can be sized and scaled using this method.

### BRIEF DESCRIPTION OF THE DRAWINGS

FIG. 1 is a cross sectional view of the human eye.

FIG. 2 is a perspective view of the human eye.

FIG. 3 shows a cross sectional view in relation to a front view of an eye in place.

FIG. 4 is a perspective view of an eye.

FIG. 5 is a front view of human eyes showing the interocular measurement.

FIG. 5a is a front view of a human face with eyeglasses fitted properly.

FIG. 6 is a front view of a human face showing various areas which can be measured.

FIG. 7 is a perspective view of a screen displaying a user performing a virtual try-on of eyewear.

FIG. 8 is a diagram of a typical communications network which may be used in conjunction with the present invention.

FIG. 9 is a flow chart of an algorithm used in the present invention.

### BEST MODE FOR CARRYING OUT THE INVENTION

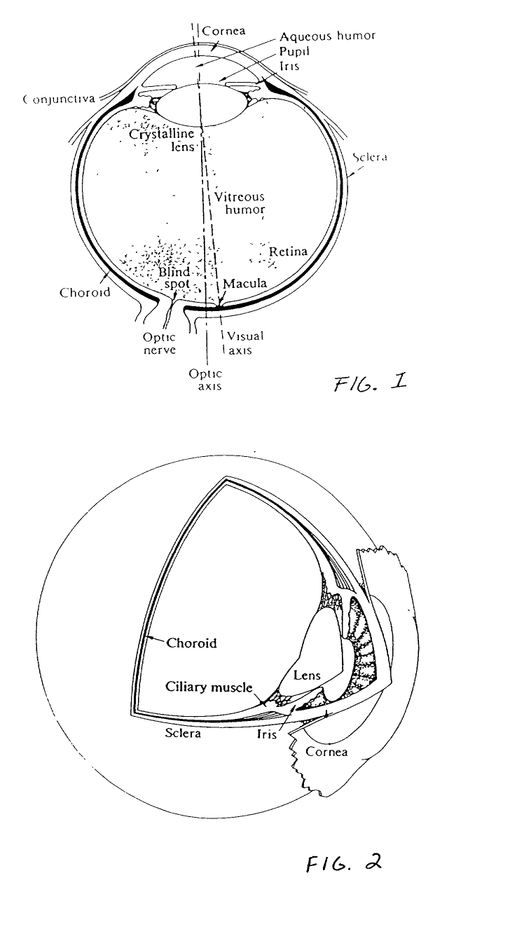

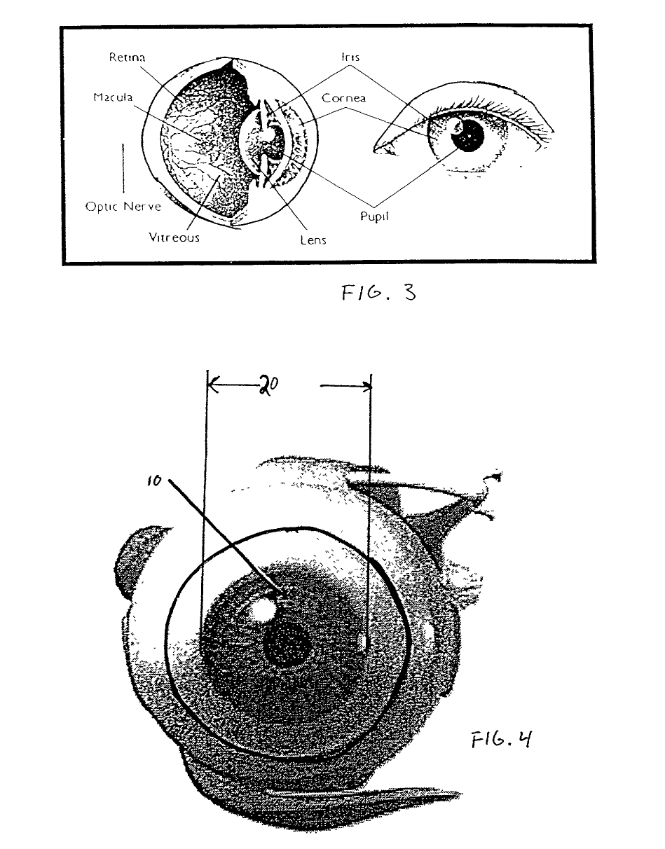

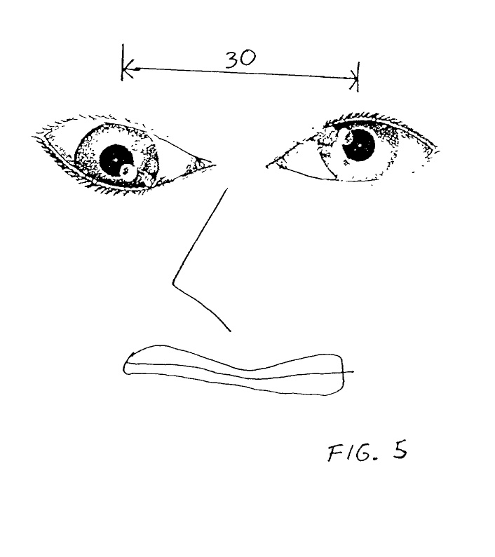

As seen in FIGS. 1 and 2, the human eye is comprised of a variety of parts, including an iris. FIG. 3 shows that the iris is the darker part that is visible when looking into someone's eye; the iris is surrounded by the white sclera, and the iris has a pupil at its center.

The present invention uses the fact that the diameter 20 of the human iris 10, as seen in FIG. 4, is effectively constant within the population of humans over age two. Any individual variations from this constant diameter 20 of the iris 10 are typically small, and do not affect the functioning of the present invention adversely.

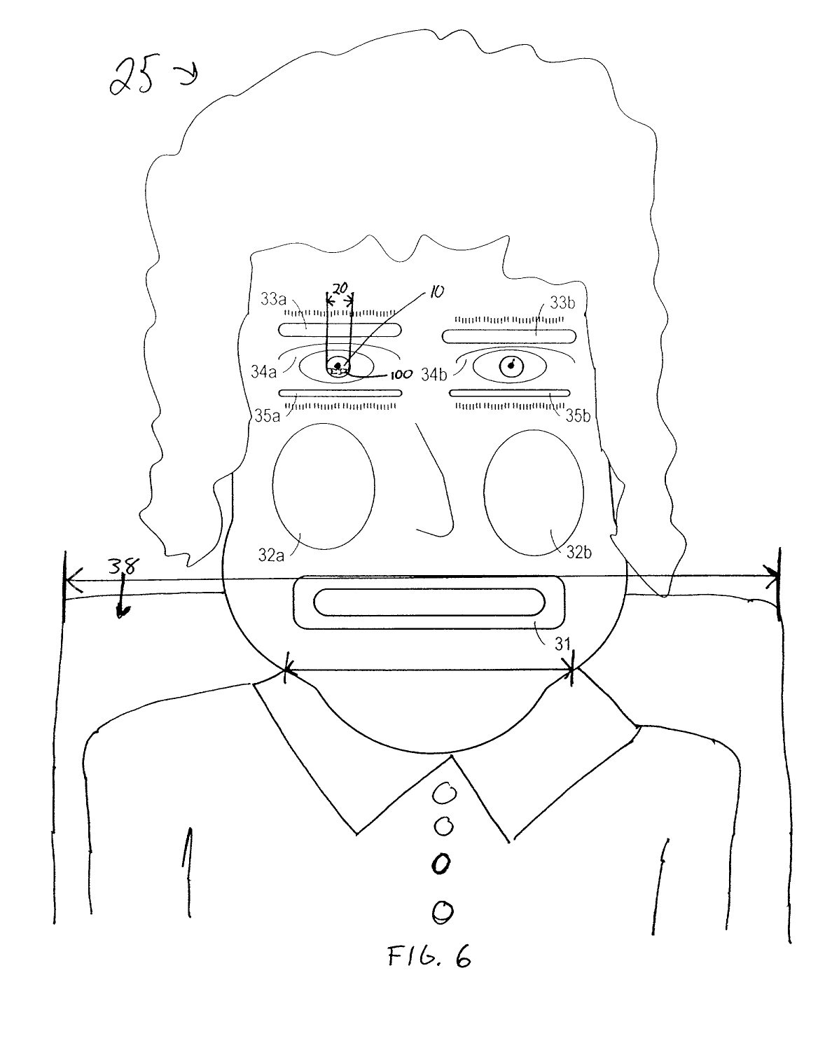

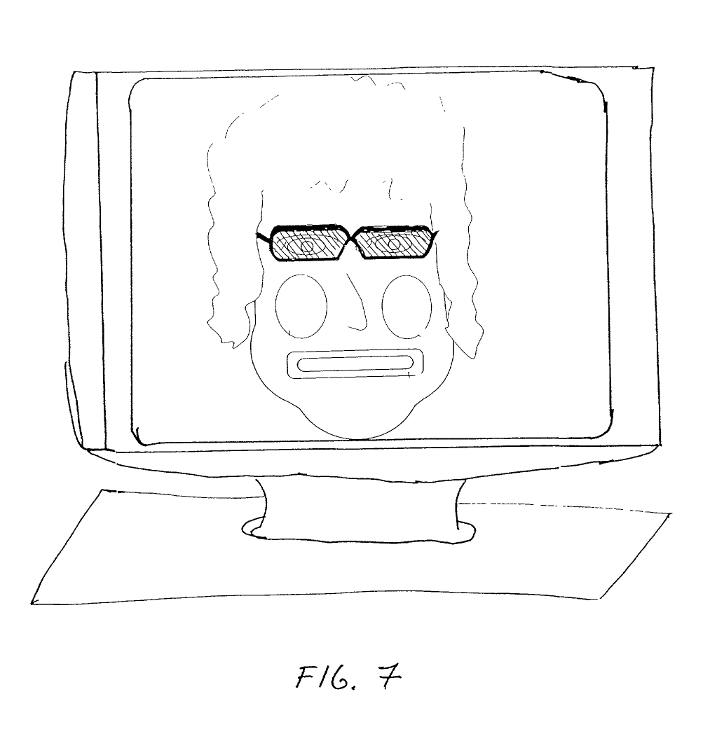

In operation, it is preferable to have an imaging system linked to a communications network as shown in FIG. 8 which takes an initial video or still image 25 of the user (see FIG. 6) via an imaging device 40 which may be a digital camera or a photographic camera The video camera 40 provides a work station 42 which includes a display screen. This initial image 25 is sent via the network to a headquarters database 44 and/or imaging workstation for processing. This image 25 is preferably in digital form at the time the image is captured (such as via a digital camera) but can also be converted to a digital image through known techniques, such as via scanning.

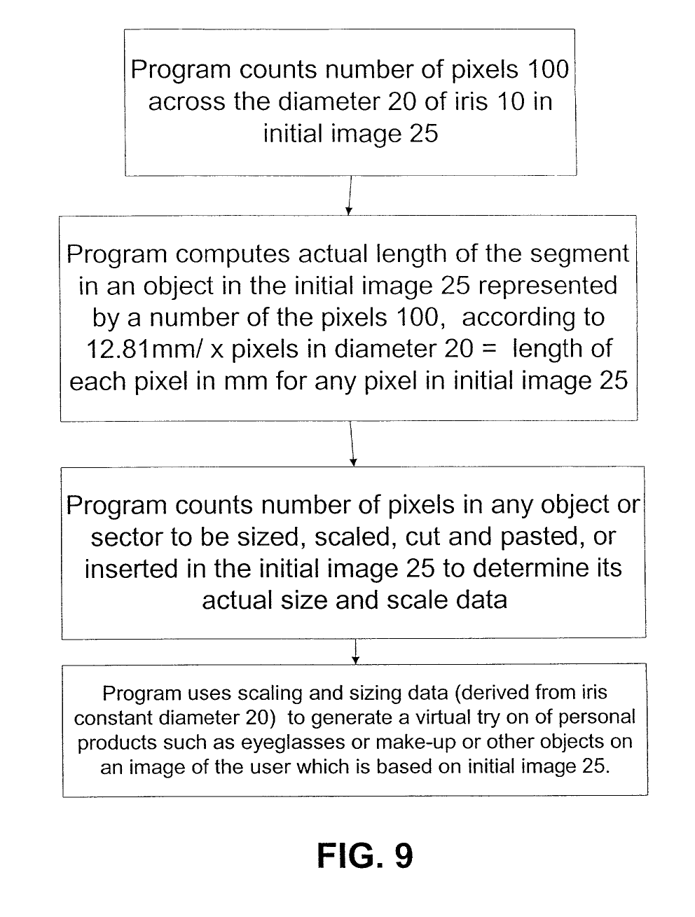

The initial image 25 contains an image of the iris 10, and the image (or an additional image) also contains an image of an object aside from the iris, for example someone's face or an inanimate object. According to a best mode embodiment for carrying out the invention, after the image or images are obtained, a size ratio is estimated between at least one dimension of the object and the iris, by analyzing the image or images. Then, the at least one dimension of the object is approximated based upon the size ratio and the invariant iris diameter of human beings. The size ratio is preferably determined using an algorithm (see FIG. 9) in a program which counts the number of pixels 100 (see FIG. 6) in the known diameter 20 of the iris 10 initial image 25. With this information, a measuring ratio of millimeters to pixels is created in the algorithm, so as to determine any distance on the image. For example, referring to FIG. 9, if the diameter 20 is 12.81 mm, then there are ten pixels in the 12.81 mm diameter 20 in the image 25, and each pixel equals 1.28 millimeters (the number 12.81 is used here merely as an example, and the actual number can be determined by mathematically analyzing precise measurements of different people). In this way, the iris acts as a built-in reference ruler, i.e., from a front view it is a circle of a constant diameter (even from a side view the iris will appear to be an ellipse having a major axis equal to the constant diameter). For example, in FIG. 6, if the width of a chair back 38 is virtually cut and pasted into the image and is next measured and designed to be a certain number of pixels in width, for example, then an actual physical chair can be ordered to the required dimensions of the user by using this virtual try-on method which uses the known diameter 20 of the iris 10 as a reference measurement in the image 25.

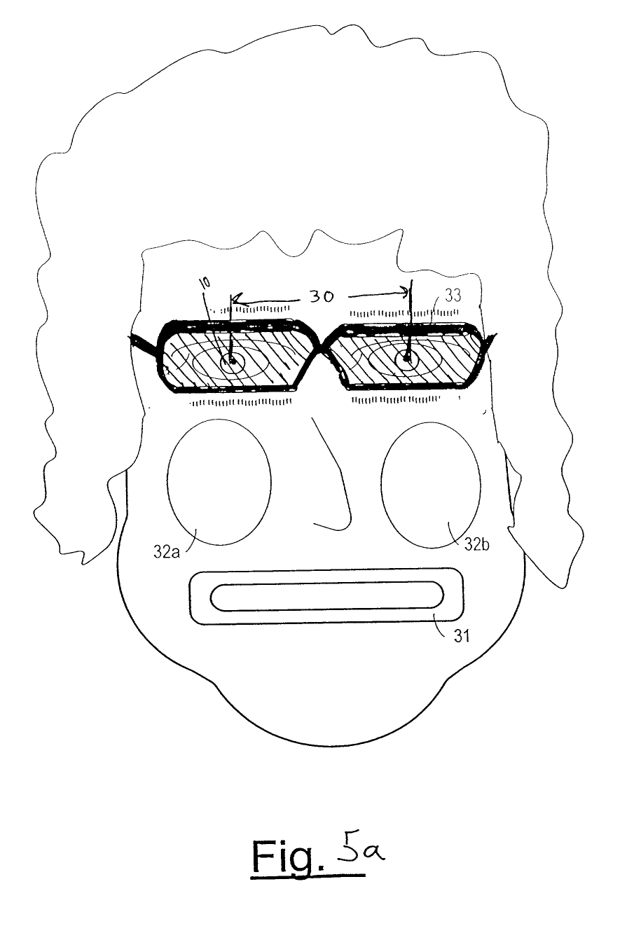

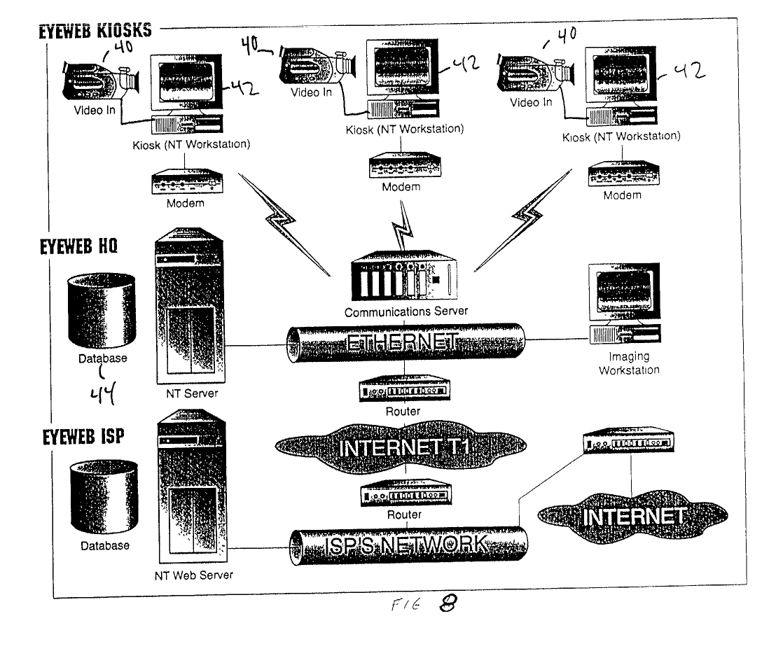

The same process may be used for fitting and scaling eyewear such as eyeglasses or sunglasses as shown in FIGS. 5, 5a, 6 and 7. FIG. 5 shows the interocular measurement 30 which varies from person to person. Referring to FIG. 6, it is easily seen, as discussed above, that the iris 10 has a constant diameter 20. Knowing this constant, as described above in detail, allows an initial image 25 (see FIG. 6) to be taken and processed, thus enabling a virtual “try-on” of eyeglasses 33 as shown in FIG. 5a, which may be displayed on a display screen as shown in FIG. 7 over the network as shown in FIG. 8. It is also apparent from FIGS. 5a and 6 that other measurements, aside from interocular distance 30, may be calculated using the present method, including mouth size 31, cheek bones 32a and 32b, eyebrows 33a and 33b, and eyelashes 34a and 34b.

In this manner, other personal products may also be virtually tried on with accurate scaling, representation, and measurement such as makeup, lipstick, rings, wigs, and other personal products. More than one image can be used in this process. For example, it may be desirable to obtain an image of a person's head including an iris, and to obtain a separate image of another body part such as a foot, using either the same imaging device or a different imaging device that is at a different elevation but at the same distance from the object (preferably the imaging devices have the same focal lengths). Moreover, the concept of invariant iris diameter may also be correct for other animal species, and therefore the present invention can be used for any species having invariant iris diameter, for example to facilitate virtual try-on of pet products.

It is also significant that, using the present invention, any image or picture from any source can be properly scaled using the iris reference measurement. This means that scaling can be performed at any location.

While in the foregoing specification, several embodiments of the invention have been set forth for purposes of making a complete disclosure, it will be apparent to those skilled in the art that numerous changes may be made without departing from the spirit and principles of the invention.

What is claimed is:

1. A method for determining at least one dimension of an object, comprising the steps of:
(a) obtaining at least one image of the object, said at least one image including an image of at least one iris of a human being,
(b) estimating at least one size ratio between the at least one dimension of the object and the at least one iris, by analyzing the image of the object, and
(c) approximating the at least one dimension of the object based upon the size ratio and the invariant iris diameter of human beings.

2. The method of claim 1, wherein the object is a facial feature.

3. The method of claim 1, wherein the size ratio is estimated in step (b) by determining how many pixels are arranged across the diameter of the iris as compared to how many pixels are arranged across the at least one dimension of the object to be measured.

4. The method of claim 2, wherein the object is a person's interocular distance.

5. The method of claim 4, wherein the method is used to fit eyewear for a person.

6. The method of claim 1, wherein a customer is located remotely from a merchant's premises, and wherein the iris is the customer's iris.

7. The method of claim 6, wherein the merchant makes available visual images which the customer observes on a display screen, the visual images showing how the merchant's products would look in conjunction with an image of the customer.

8. The method of claim 7, wherein the iris is circular but appears elliptical when viewed from an angle, and wherein the invariant iris diameter is a major axis of an ellipse when the iris is viewed from said angle.

9. A method by which a merchant assists a customer who uses a display screen and an imaging device to shop for products, comprising the steps of:
(a) receiving at least one image of the customer from the imaging device, wherein at least one of the at least one image includes an image of at least one iris of the customer,
(b) providing the customer with a selection of products,
(c) receiving information from the customer about a product that the customer wants to virtually try on,
(d) providing the customer with a product image which corresponds to the product that the customer wants to virtually try on, and which is combined with the at least one image of the customer, and
(e) determining an appropriate size of the product suitable for the customer, based upon the at least one image of the customer,
wherein the appropriate size of the product is determined by using the invariant diameter of a human iris as a measuring device.

10. The method of claim 9, wherein the customer is located at a remote location from the merchant.

11. The method of claim 9, wherein the product that the customer wants to virtually try on is eyewear.

12. The method of claim 9,
wherein the circular iris appears elliptical if viewed at a nonperpendicular angle by the imaging device, so that the iris has a longest diameter which is a major axis of an ellipse, and
wherein the longest diameter is the invariant diameter of the human iris.

13. A method for determining at least one dimension of an object, comprising the steps of:
(a) obtaining at least one image of the object, said at least one image including an image of at least one iris,
(b) estimating at least one size ratio between the at least one dimension of the object and the at least one iris, by analyzing the image of the object, and
(c) approximating the at least one dimension of the object based upon the size ratio and the invariant iris diameter of a species.

14. A system for enabling a merchant to assist a customer who is shopping for products, comprising:
(a) at least one imaging device for receiving at least one image of the customer, wherein at least one of the at least one image includes an image of at least one iris of the customer,
(b) a display screen for visually providing the customer with a selection of products,
(c) information receiving means for receiving information from the customer about a product that the customer wants to virtually try on,
(d) means for generating a product image which corresponds to the product that the customer wants to virtually try on, wherein the product image is combined with the at least one image of the customer and wherein the product image is provided to the customer, and
(e) means for determining an appropriate size of the product suitable for the customer, based upon the at least one image of the customer,
wherein the appropriate size of the product is determined by using the invariant diameter of a human iris as a measuring device.

15. The system of claim 15, wherein the customer is located at a remote location from the merchant.

16. The system of claim 15, wherein the product that the customer wants to virtually try on is eyewear.

17. The system of claim 15,
wherein the circular iris appears elliptical if viewed at a nonperpendicular angle by the imaging device, so that the iris has a longest diameter which is a major axis of an ellipse, and
wherein the longest diameter is the invariant diameter of the human iris.
